(19) United States
(12) Patent Application Publication
(10) Pub. No.: US 2025/0246422 A1
(43) Pub. Date: Jul. 31, 2025

(54) ION GUIDE ELECTRODE CONFIGURATIONS FOR ION TRANSPORT AND CONFINEMENT

(71) Applicant: Thermo Fisher Scientific (Bremen) GmbH, Bremen (DE)

(72) Inventor: Hamish Stewart, Bremen (DE)

(21) Appl. No.: 18/428,340

(22) Filed: Jan. 31, 2024

(51) Int. Cl. H01J 49/06

(52) U.S. Cl. CPC H01J 49/066

(57) ABSTRACT

An ion guide includes a plurality of elongate first electrodes and second electrodes arranged along an ion path in an alternating pattern. The first electrodes are configured to receive first RF voltages and the second electrodes are configured to receive second RF voltages that are phase-shifted with respect to the first RF voltages. At least an outer edge portion of each of the first electrodes and second electrodes is arranged at an angle oblique to both the ion path and a direction perpendicular to the ion path. When the first electrodes receive first RF voltages and the second electrodes receive second RF voltages, the first electrodes and the second electrodes exert a force having a first component along the ion path to guide ions along the ion path and a second component along the direction perpendicular to the ion path to confine ions within the ion path.

### BACKGROUND INFORMATION

Ion guides are devices that guide ions along an ion path by application of electrostatic and electrodynamic fields and/or by a carrier gas. Ion guides may be used, for example, to transport ions within a mass spectrometer or to separate ions within an ion mobility device. Conventional ion guides may be formed of multipole arrangements, such as linear quadrupole devices, or electrode arrangements on opposing surfaces, such as printed circuit boards (PCBs). PCB ion guides are appealing due to their low cost and the possibility of creating complex geometries with a fairly simple printing process. However, conventional configurations of PCB ion guides have various drawbacks. For example, to maintain ions within the ion path, some PCB ion guides apply a radio frequency (RF) voltage to inner RF electrodes to provide a trapping potential in a Y (vertical) direction and apply a direct current (DC) voltage to outer guard electrodes to provide a trapping potential in an X (horizontal) direction. Ions are guided along the ion path along a Z axis by application of a DC gradient electric field or an RF traveling wave. However, the trapping potential generated by the DC guard electrodes can trap ions of only a single polarity. Other PCB ion guides use additional RF electrodes positioned in the space between the upper and lower PCBs to provide polarity independent trapping along the X axis. However, these additional voltages and outer guard electrodes require additional driving electronics and complicate the design and manufacture of the ion guides.

### SUMMARY

The following description presents a simplified summary of one or more aspects of the methods and systems described herein in order to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects of the methods and systems described herein in a simplified form as a prelude to the more detailed description that is presented below.

In some illustrative examples, an ion guide comprises a plurality of elongate first electrodes arranged along an ion path and configured to receive first RF voltages and a plurality of elongate second electrodes arranged along the ion path in an alternating pattern with the plurality of first electrodes and configured to receive second RF voltages that are phase-shifted with respect to the first RF voltages, wherein at least an outer edge portion of each of the plurality of elongate first electrodes and the plurality of elongate second electrodes is arranged at a first angle oblique to both the ion path and a direction perpendicular to the ion path.

In some illustrative examples, an ion guide comprises a plurality of elongate first electrodes arranged along an ion path and configured to receive first RF voltages and a plurality of elongate second electrodes arranged along the ion path in an alternating pattern with the plurality of first electrodes and configured to receive second RF voltages that are phase-shifted with respect to the first RF voltages, wherein at least an outer edge portion of each of the plurality of elongate first electrodes and the plurality of elongate second electrodes is arranged at an angle relative to the ion path such that, when the plurality of elongate first electrodes receive first RF voltages and the plurality of elongate second electrodes receive second RF voltages, the plurality of elongate first electrodes and the plurality of elongate second electrodes exert a force having a first component along the ion path to guide ions along the ion path and a second component along the direction perpendicular to the ion path to confine ions within the ion path.

In some illustrative examples, a method of guiding ions within an ion guide comprising a plurality of elongate first electrodes and a plurality of elongate second electrodes arranged along an ion path in an alternating pattern and at an angle oblique to both the ion path and a direction perpendicular to the ion path comprises: applying first RF voltages to the plurality of elongate first electrodes and applying second RF voltages to the plurality of elongate second electrodes to generate a traveling wave potential having a first component that guides ions along the ion path and a second component to confine the ions within the ion path along the direction perpendicular to the ion path and introducing ions to the ion guide.

### BRIEF DESCRIPTION OF THE DRAWINGS

The accompanying drawings illustrate various examples and are a part of the specification. The illustrated examples are merely examples and do not limit the scope of the disclosure. Throughout the drawings, identical or similar reference numbers designate identical or similar elements.

FIG. 1 shows a perspective view of an illustrative ion guide.

FIG. 2 shows a cross-sectional view of the ion guide of FIG. 1 taken along the dash-dot-dash line labeled II in FIG. 1.

FIGS. 3A and 3B show cross-sectional views of the ion guide of FIG. 1 taken along the dash-dot-dash line labeled III in FIG. 2.

FIG. 4 shows a cross-sectional view of the ion guide of FIG. 1 taken along the dash-dot-dash line labeled IV in FIG. 3A as well as force components generated by electrodes of the ion guide when the electrodes receive voltages.

FIGS. 5A and 5B show a simulation of illustrative ion trajectories of ions within the ion guide of FIG. 1 when the electrodes receive voltages.

FIGS. 6-9 show alternative configurations of electrodes on a surface.

FIG. 10A shows a side view of another illustrative ion guide.

FIG. 10B shows a plan view of the ion guide of FIG. 10A.

FIG. 10C shows a perspective view of an electrode of the ion guide of FIG. 10A.

FIG. 11 shows a perspective view of another illustrative ion guide.

FIGS. 12-14A show alternative configurations of electrodes on a surface.

FIG. 14B shows a plan view of another illustrative ion guide incorporating the electrodes of FIG. 14A.

FIG. 15 shows a mass spectrometry system incorporating an ion guide according to the principles described herein.

FIG. 16 shows a flowchart of an illustrative method of guiding ions.

FIG. 17 shows a flowchart of an illustrative method of making an ion guide.

### DETAILED DESCRIPTION

Illustrative ion guides that include electrodes configured to simultaneously transport and confine ions when supplied with RF voltages are described herein. In some examples, an ion guide includes a plurality of elongate first electrodes and a plurality of elongate second electrodes arranged along an ion path. The plurality of elongate second electrodes are arranged along the ion path in an alternating pattern with the plurality of elongate first electrodes. Additionally, at least an outer edge of each of the plurality of elongate first electrodes and the plurality of elongate second electrodes is arranged at an angle oblique to both the ion path and a direction perpendicular to the ion path. The plurality of elongate first electrodes is configured to receive first RF voltages and the plurality of elongate second electrodes is configured to receive second RF voltages that are phase-shifted with respect to the first RF voltages. When the plurality of elongate first electrodes receive the first RF voltages and the plurality of elongate second electrodes receive the second RF voltages, the plurality of elongate first electrodes and the plurality of elongate second electrodes exert a force having a first component along the ion path to guide ions along the ion path and a second component along the direction perpendicular to the ion path to confine ions within the ion path.

The ion guides described herein have various advantages over conventional ion guides. For example, the electrode configurations described herein exert a force having multiple components, such as a first component along the ion path (e.g., a first horizontal direction) and a second component along the direction perpendicular to the ion path (e.g., a second horizontal direction) to simultaneously guide ions along the ion path and confine ions within the ion path. Furthermore, the ion guides described herein have a simple construction because the ion guidance along the ion path is provided by the same electrodes that provide ion confinement along the direction perpendicular to the ion path. Hence, the same electronic drive circuitry is used to generate the force having components in both the direction along the ion path and the direction perpendicular to the ion path, thus simplifying the construction and operation of the ion guides.

Various examples will now be described in more detail with reference to the figures. The systems and methods described herein may provide one or more of the benefits mentioned above and/or various additional and/or alternative benefits that will be made apparent herein.

Unless otherwise specified or indicated by context, the terms “a”, “an”, and “the” mean “one or more.” For example, “a molecule” should be interpreted to mean “one or more molecules.”

As used herein, “about” and “substantially” are understood by persons of ordinary skill in the art and vary to some extent given the context in which they are used. If there are uses of the terms that are not clear to persons of ordinary skill in the art given the context in which they are used, “about” and “substantially” mean less than or equal to 10% of the particular value.

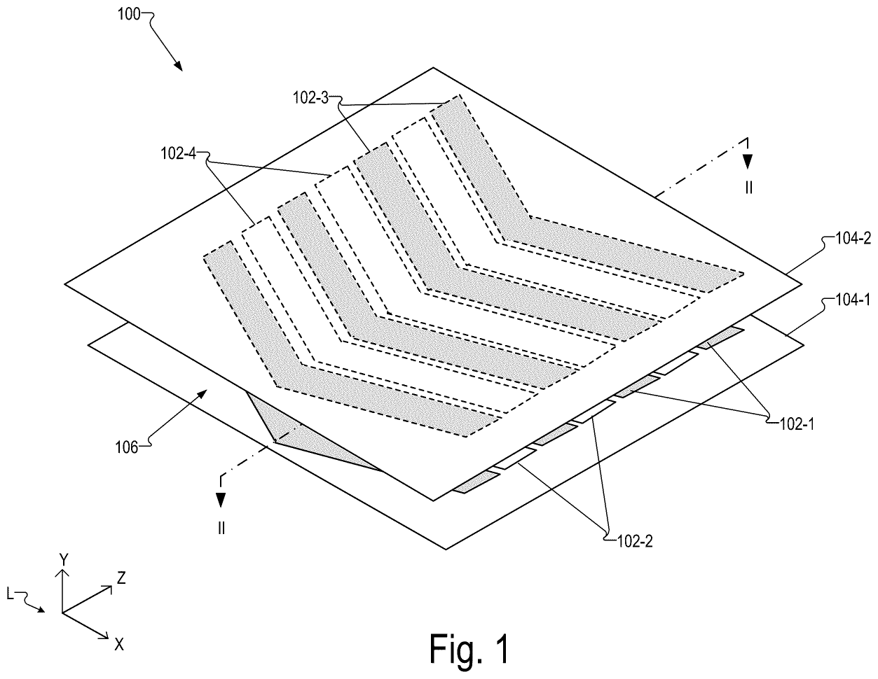

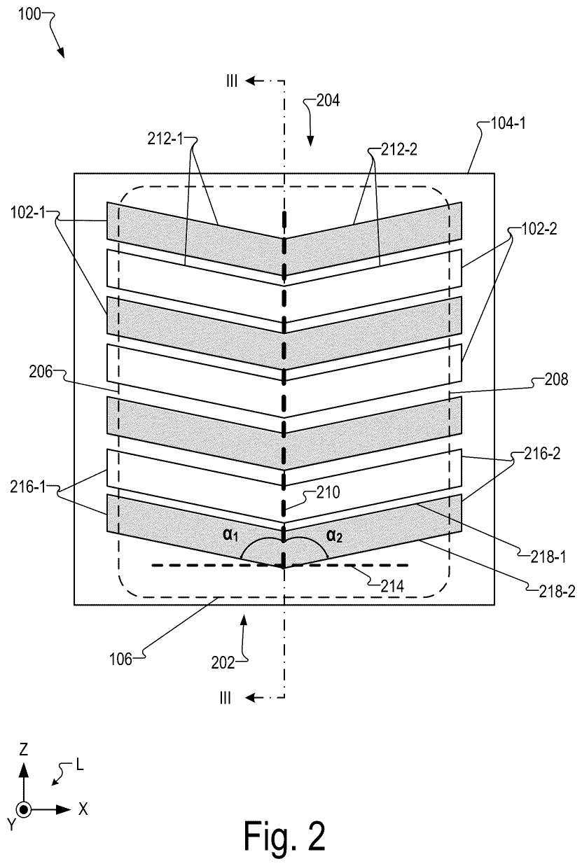

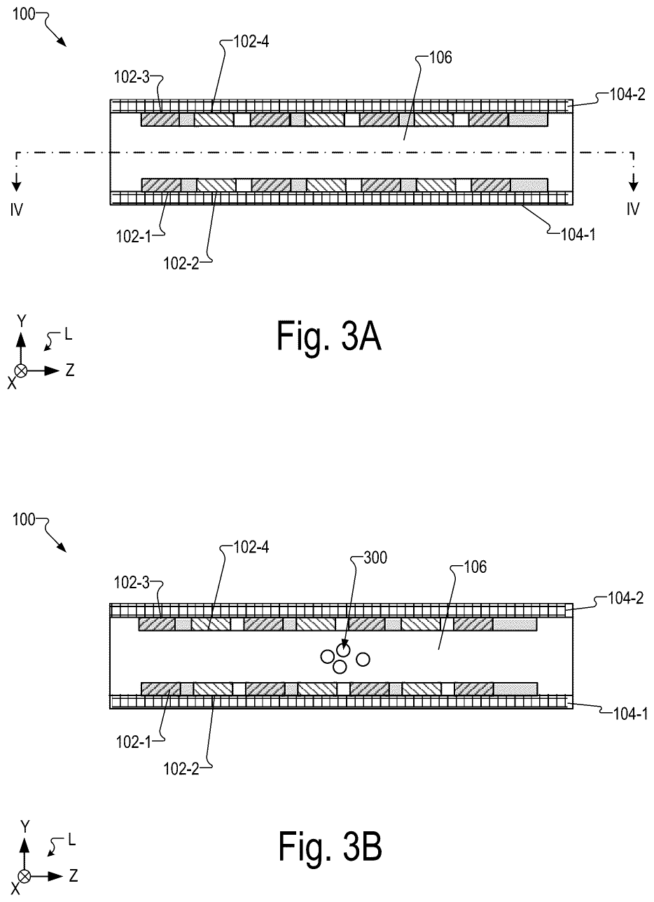

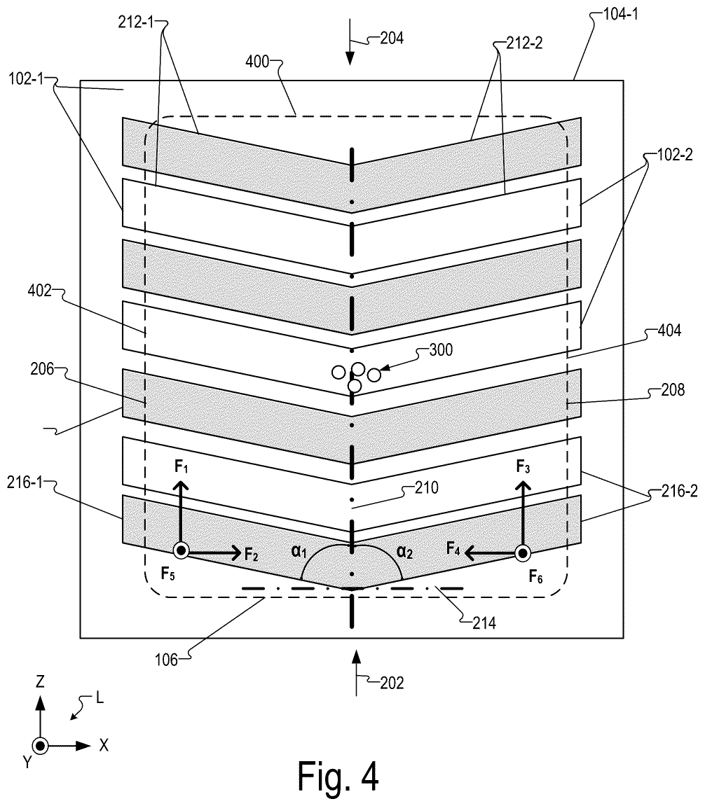

FIGS. 1-4 show various views of an illustrative ion guide 100. FIG. 1 shows a perspective view of ion guide 100. FIG. 2 shows a cross-sectional view of ion guide 100 taken along the dash-dot-dash line labeled II in FIG. 1. FIGS. 3A and 3B show cross-sectional views of ion guide 100 taken along the dash-dot-dash line labeled III in FIG. 2. FIG. 4 shows a cross-sectional view of ion guide 100 taken along the dash-dot-dash lines labeled IV in FIG. 3A.

Ion guide 100 includes a plurality of elongate first electrodes 102-1 (shown in gray shading) and a plurality of elongate second electrodes 102-2 (shown without shading) arranged in an alternating pattern. As shown, the plurality of elongate first electrodes 102-1 and the plurality of elongate second electrodes 102-2 are arranged on a first surface 104-1. Ion guide 100 further includes a plurality of elongate third electrodes 102-3 (shown in gray shading) and a plurality of elongate fourth electrodes 102-4 (shown without shading) arranged in an alternating pattern. The plurality of elongate third electrodes 102-3 and the plurality of elongate fourth electrodes 102-4 are arranged on a second surface 104-2 opposite to first surface 104-1. In FIG. 1, electrodes 102 on second surface 104-2 are shown in broken line to indicate that the electrodes 102 are positioned on a side of second surface 104-2 facing first surface 104-1. Second surface 104-2 is spaced away from first surface 104-1 to form an ion containment space 106 therebetween. Although not shown, ion guide 100 may include other components as may suit a particular implementation, such as spacers that maintain a spacing between first surface 104-1 and second surface 104-2, a voltage source and wiring for connecting electrodes 102 to the voltage source, and electronics for controlling a voltage applied to electrodes 102.

FIGS. 1-4 are merely representative of ion guide 100, as ion guide 100 may have any other number and arrangement of electrodes 102. For example, while FIGS. 1-4 show that first surface 104-1 and second surface 104-2 each have seven electrodes 102, first surface 104-1 and second surface 104-2 may have any other number of electrodes 102 as may suit a particular implementation.

FIGS. 1-4 show a legend L of a 3D coordinate system that has been arbitrarily oriented so that a longitudinal axis of ion containment space 106 (e.g., an ion propagation direction when ion guide 100 is a transmission device) extends along the Z axis and first surface 104-1 and second surface 104-2 each lie in an XZ plane and are positioned opposite one another along the Y axis. As used herein, an X, Y, or Z axis refers to the X, Y, or Z axis of legend L or any other 3D coordinate system oriented similarly to legend L. For example, an “X axis” may refer to the X axis of legend L or any other axis parallel to the X axis of legend L, a “Y axis” may refer to the Y axis of legend L or any other axis parallel to the Y axis of legend L, and a “Z axis” may refer to the Z axis of legend L or any other axis parallel to the Z axis of legend L.

First surface 104-1 and second surface 104-2 are planar surfaces positioned substantially parallel to one another and facing one another with a gap therebetween. First surface 104-1 and second surface 104-2 may each be implemented by any suitable planar structure, such as a PCB or a solid substrate (e.g., a glass substrate, a ceramic substrate, a polymer substrate, etc.). In other examples, first surface 104-1 and second surface 104-2 are not planar but have a curved, contoured, or other non-planar shape as may suit a particular implementation.

Ion containment space 106 is a volume in the gap between first surface 104-1 and second surface 104-2 in which ions may be confined (e.g., trapped) and/or guided (e.g., driven, transported, propelled, etc.) by generating one or more confinement fields. For example, as will be explained below in more detail, pairs of opposing electrodes 102 across ion containment space 106 may receive one or more RF voltages (e.g., RF traveling wave voltages and/or RF trapping voltages) and/or DC voltages (e.g., DC gradient voltages) to thereby generate one or more forces to confine and/or guide ions within ion containment space 106. Ion containment space 106 may be under vacuum, low pressure, or high pressure.

In some examples, ions are confined within ion containment space 106 by application of RF voltages and/or DC voltages to electrodes 102 to generate one or more confinement fields to prevent ions from colliding with first surface 104-1 and second surface 104-2 and to prevent ions from escaping out of ion guide at sides of ion containment space 106.

In some examples, ion guide 100 is a transmission type device in which ion containment space 106 forms an ion path through which ions are guided. Ions may be guided through ion containment space 106 in any suitable way, such as by applying RF traveling wave voltages and/or DC gradient voltages to electrodes 102 (or to other electrodes not shown) to superimpose on the one or more confinement fields an RF traveling wave (e.g., RF pulses that move from one electrode to the next), a DC gradient field (e.g., by using a voltage divider), and/or a DC traveling wave (e.g., DC pulses that move from one electrode to the next). In some examples, two directions of force (e.g., two orthogonal force vectors) are applied to ions in the ion guide 100 using a single traveling wave voltage applied to the ion guide, as taught herein. Additionally or alternatively, ions may be guided through ion containment space 106 by passing a carrier gas through ion containment space 106. In other examples, ion guide 100 is a trapping type device in which ion containment space 106 is a trapping volume in which ions are trapped by one or more confinement fields until the ions are ejected from ion containment space 106.

Referring now to FIG. 2, ion containment space 106 (represented by the thin dashed line) includes an entrance aperture 202, an exit aperture 204, a first side 206, and a second side 208. Entrance aperture 202 is an opening for the introduction of ions into ion containment space 106 and exit aperture 204 is an opening through which ions may exit or be ejected from ion containment space 106. Entrance aperture 202 is located at an upstream end of ion containment space 106 and exit aperture 204 is located at a downstream end of ion containment space 106. However, entrance aperture 202 and/or exit aperture 204 may be located at any other location as may suit a particular implementation, such as at first side 206 or at second side 208. First side 206 and second side 208 extend along the longitudinal axis (e.g., the Z axis) of ion containment space 106 opposite one another. For example, as shown in FIG. 2, first side 206 is located at a −X side of ion containment space 106 and second side 208 is located at a +X side of ion containment space 106.

Electrodes 102 are formed of an electrically conductive material (e.g., a metal) and are configured to receive RF voltages and/or DC voltages. Electrodes 102 are arranged along an ion path to define ion containment space 106. For example, the plurality of elongate first electrodes 102-1 and the plurality of elongate second electrodes 102-2 are alternatingly arranged on first surface 104-1 along the longitudinal axis (e.g., the Z axis) of ion containment space 106 to form an ion path having a central axis 210 (e.g., the Z axis, represented by the thick dashed line). Accordingly, the ion path extends longitudinally within ion containment space 106, such as from entrance aperture 202 to exit aperture 204, between first side 206 and second side 208 of ion containment space 106. In the example of FIG. 2, central axis 210 of the ion path corresponds to the longitudinal axis of ion containment space 106. However, central axis 210 of the ion path is not limited to this configuration, but may have any other suitable shapes (e.g., curved, wavy, or irregular) and/or orientation relative to the longitudinal axis of ion containment space 106.

As shown, each electrode 102 includes a first portion 212-1 and a second portion 212-2. First portion 212-1 has an elongate rectangular shape that extends outwardly from central axis 210 of the ion path toward first side 206 of ion containment space 106 and second portion 212-2 has an elongate rectangular shape that extends outwardly from central axis 210 of the ion path toward second side 208 of ion containment space 106. Accordingly, each electrode 102 and/or portions 212 of each electrode 102 has a length (e.g., spans a distance) along a direction 214 perpendicular to the ion path (e.g., the X axis) that is greater than a width (or span) of each electrode 102 along the ion path (e.g., the Z axis) such that each electrode 102 is elongate. To illustrate, each portion 212 of electrodes 102 includes side edges 218 (e.g., side edges 218-1 through 218-2) extending outwardly from central axis 210 that are longer than an outer edge (e.g., outer edges 216-1 and 216-2 that join side edges 218-1 and 218-2) of each portion 212 extending along the ion path. However, portions 212 of electrodes 102 are not limited to this configuration and may have any other suitable shape (e.g., curved, elliptical, oval, wavy, or irregular). Other configurations of electrodes 102 will be described below in more detail. Additionally, while the illustrated example shows first portion 212-1 formed integrally with second portion 212-2, first portion 212-1 may alternatively be separate from second portion 212-2 with a space or gap therebetween (e.g., first portion 212-1 may be spaced away from second portion 212-2, such as at central axis 210 so that first portion 212-1 is located on the −X side of ion containment space 106 and second portion 212-2 is located on the +X side of ion containment space 106).

Each first portion 212-1 and second portion 212-2 of plurality of elongate first electrodes 102-1 and plurality of elongate second electrodes 102-2 is arranged at an angle α oblique to both the ion path (e.g., central axis 210) and direction 214 perpendicular to the ion path (e.g., the X axis). For example, each first portion 212-1 is arranged at a first angle α₁ oblique to central axis 210 of the ion path and direction 214 perpendicular to central axis 210 (e.g., first portion 212-1 is oriented between the X axis and the Z axis on the −X side of ion containment space 106). Likewise, each second portion 212-2 is arranged at a second angle α₂ oblique to central axis 210 of the ion path and direction 214 perpendicular to central axis 210 (e.g., second portion 212-2 is oriented between the X axis and the Z axis on the +X side of ion containment space 106). As shown, at least one side edge 218 of each portion 212 is arranged at angle α oblique to both the ion path and direction 214 perpendicular to the ion path.

In some examples, each angle α is between about 15 degrees and about 70 degrees relative to the ion path (e.g., central axis 210), such as between about 20 degrees and about 65 degrees, between about 25 degrees and about 60 degrees, between about 30 degrees and about 60 degrees, between about 30 degrees and about 55 degrees, between about 40 degrees and about 50 degrees, or about 45 degrees. In the illustrated example, each first portion 212-1 is oriented at the same first angle α₁ and each second portion 212-2 is oriented at the same second angle α₂ that is substantially equal to first angle α₁. However, portions 212 of electrodes 102 are not limited to this configuration, as one or more portions 212 may be oriented at different angles α oblique to the ion path and direction 214 perpendicular to the ion path.

As shown in FIG. 2, each first portion 212-1 of electrodes 102 is arranged at an angle relative to each second portion 212-2 such that each first portion 212-1 is angled less than 180 degrees relative to each second portion 212-2. In the illustrated example, the angle between each first portion 212-1 and each second portion 212-2 is the sum of first angle α₁ and second angle α₂. In some examples, the angle between portions 212 is between about 30 degrees and about 140 degrees, between about 40 degrees and about 130 degrees, between about 50 degrees and about 120 degrees, between about 60 degrees and about 120 degrees, between about 60 degrees and about 110 degrees, between about 80 degrees and about 100 degrees, or about 90 degrees.

At least an outer edge portion of each first electrode 102-1 and second electrode 102-2 is arranged at angle α oblique to both the ion path (e.g., central axis 210) and direction 214 perpendicular to the ion path. For example, an outer edge portion of each first portion 212-1 includes a portion of each electrode 102 extending inwardly from a first outer edge 216-1 of first portion 212-1 toward central axis 210. Similarly, an outer edge portion of each second portion 212-2 includes a portion of each electrode 102 extending inwardly from a second outer edge 216-2 of second portion 212-2 toward central axis 210 (e.g., outer edge portions may include at least about 10% by length of each portion 212 extending inwardly from outer edges 216, at least about 25% of each portion 212 extending inwardly from outer edges 216, at least about 50% of each portion 212 extending inwardly from outer edges 216, at least about 75% of each portion 212 extending inwardly from outer edges 216, etc.). In the illustrated example, each first portion 212-1 and second portion 212-2 of electrodes 102 is linear and thus the entirety of first portion 212-1 and second portion 212-2 are positioned at the same oblique angle α relative to central axis 210. In other examples (not shown), less than the entirety of each portion 212 may be positioned at angle α. To illustrate, electrodes 102 may include a central portion extending across central axis 210 along direction 214 perpendicular to the ion path while outer edge portions of 212 are oblique to the ion path and direction 214 perpendicular to the ion path.

FIG. 2 shows first portion 212-1 and second portion 212-2 of electrodes 102 as substantially symmetrical across central axis 210 of the ion path. For example, first electrodes 102-1 and second electrodes 102-2 have a V-shape or chevron configuration. However, electrodes 102 are not limited to this configuration. For example, first portion 212-1 and second portion 212-2 may alternatively be asymmetrical across central axis 210 (e.g., first angle α₁ may be different than second angle α₂, first portion 212-1 may have a different shape than second portion 212-2, first portion 212-1 may have a different length (e.g., along the X axis) and/or width (e.g., along the Z axis) than second portion 212-2, etc.).

FIGS. 3A and 3B show first surface 104-1 positioned opposite to second surface 104-2 to define ion containment space 106 therebetween. First surface 104-1 includes a plurality of first electrodes 102-1 and a plurality of second electrodes 102-2 alternately arranged along the ion path. As shown, the plurality of elongate first electrodes 102-1 and the plurality of elongate second electrodes 102-2 are arranged on first surface 104-1 such that first electrodes 102-1 and second electrodes 102-2 extend from first surface 104-1 within ion containment space 106. In some examples, first electrodes 102-1 and second electrodes 102-2 are attached (e.g., printed, mounted, fastened, glued, printed, embedded within, etc.) directly to first surface 104-1 and/or are spaced away from first surface 104-1 within ion containment space 106. Still other suitable configurations for electrodes 102 may be used. For example, electrodes 102 may additionally or alternatively be flush with surface 104-1 and/or arranged on an opposite side of surface 104-1.

Second surface 104-2 includes a plurality of third electrodes 102-3 and a plurality of fourth electrodes 102-4, which may be arranged on second surface 104-2 in a manner similar to the plurality of first electrodes 102-1 and the plurality of second electrodes 102-2, respectively. As shown, the plurality of third electrodes 102-3 are positioned opposite of the plurality of first electrodes 102-1 and the plurality of fourth electrodes 102-4 are positioned opposite of the plurality of elongate second electrodes 102-2. However, electrodes 102 are not limited to this configuration. For example, the plurality of third electrodes 102-3 may be positioned opposite of the plurality of elongate second electrodes 102-2 and the plurality of fourth electrodes 102-4 may be positioned opposite the plurality of elongate first electrodes 102-1 and/or the plurality of third electrodes 102-3 and the plurality of fourth electrodes 102-4 may be offset relative to the plurality of elongate first electrodes 102-1 and the plurality of elongate second electrodes 102-2.

As mentioned, electrodes 102 are configured to receive RF voltages and/or DC voltages and thereby generate one or more forces that confine ions 300 within ion containment space 106 and/or guide ions 300 along the ion path. For example, in a first voltage scheme, electrodes 102 are configured to receive RF trapping voltages to apply an RF trapping potential along the Y axis to confine ions 300 between first surface 104-1 and second surface 104-2. Electrodes 102 are further configured to receive RF traveling wave voltages to superimpose on the RF trapping potential an RF traveling wave potential along the X axis (e.g., towards central axis 210) to confine ions 300 between first side 206 and second side 208 of ion containment space 106 and along the Z axis to guide ions 300 along the ion path.

To illustrate, the RF traveling wave voltages may include transient RF voltages applied to certain electrodes 102 so that potential wells are formed between these electrodes 102 to create trapping regions within ion containment space 106. The transient RF voltages are then progressively applied to subsequent electrodes 102 so that the trapping regions move along ion guide 100, which may be referred to as a “traveling wave potential”. When electrodes 102 receive RF traveling wave voltages to generate the traveling wave potential, the traveling wave potential is applied along the ion path (e.g., central axis 210) to guide the ions along the ion path. An amplitude and/or frequency of the traveling wave may vary, such as based on a size of ion containment space 106 and/or as a function of position along the surface (e.g., along the central axis 210).

Still other suitable voltage schemes may be used. For example, in a second voltage scheme, electrodes 102 are configured to receive the RF trapping voltages to apply the RF trapping potential along the Y axis to confine ions 300 between first surface 104-1 and second surface 104-2. Electrodes 102 are further configured to receive DC gradient voltages to superimpose on the RF trapping potential a DC gradient potential along the X axis (e.g., towards central axis 210) to confine ions 300 between first side 206 and second side 208 of ion containment space 106 and along the Z axis to guide ions 300 along the ion path. Alternatively, in a third voltage scheme, electrodes 102 are configured to receive RF traveling wave voltages, which generate an RF trapping potential along the Y axis to confine ions 300 between first surface 104-1 and second surface 104-2 and which apply an RF traveling wave potential along the X axis and the Z axis, to thereby confine and guide ions 300 within the ion path.

Electrodes 102 are configured to receive RF voltages (e.g., RF trapping voltages and/or RF traveling wave voltages) such that first electrodes 102-1 are configured to receive first RF voltages, second electrodes 102-2 are configured to receive second RF voltages, third electrodes 102-3 are configured to receive third RF voltages, and fourth electrodes 102-4 are configured to receive fourth RF voltages. In the configurations described above, the second RF voltages are phase-shifted with respect to the first RF voltages and the fourth RF voltages are phase-shifted with respect to the third RF voltages. In some instances, first electrodes 102-1 and third electrodes 102-3 are configured to receive RF voltages having the same phase and second electrodes 102-2 and fourth electrodes 102-4 are configured to receive RF voltages of the same phase but are phase-shifted with respect to the RF voltages received by first electrodes 102-1 and third electrodes 102-3. In the figures, electrodes 102 of a first phase (e.g., first electrodes 102-1 and third electrodes 102-3) are shaded gray and electrodes 102 of a second phase (e.g., second electrodes 102-2 and fourth electrodes 102-4) are not shaded. In some examples, the RF voltages received by first electrodes 102-1 and third electrodes 102-3 are 180° out of phase with the RF voltages received by second electrodes 102-2 and fourth electrodes 102-4.

In some examples, first electrodes 102-1 and third electrodes 102-3 are connected to a first circuit (not shown) configured to supply first RF voltages from a voltage source (not shown) and second electrodes 102-2 and fourth electrodes 102-4 are connected to a second circuit (not shown) configured to supply second RF voltages from the same voltage source or a different voltage source. The second RF voltages are phase-shifted with respect to the first RF voltages. In examples in which the voltage source is the same for the first circuit and the second circuit, either the first circuit or the second circuit may include any suitable phase shift circuit or phase shift module. In some examples, electrodes 102 are configured to further receive DC voltages, such as to apply a DC gradient potential along the ion path, as described in more detail below. Alternatively, first electrodes 102-1 and third electrodes 102-3 may receive first RF voltages, while second electrodes 102-2 and fourth electrodes 102-4 receive DC voltages and/or are grounded.

FIG. 4 depicts illustrative components of forces generated by electrodes 102 when electrodes 102 receive voltages according to one of the voltage schemes described above. As shown, when first electrodes 102-1 and second electrodes 102-2 receive RF traveling wave voltages or DC gradient voltages as described above, first portions 212-1 generate a force having a first component F₁ and a second component F₂ and second portions 212-2 generate a force having a third component F₃ and a fourth component F₄. For example, due to the angled orientation of the outer edge portion of first portions 212-1 at first angle α relative to the ion path, first component F₁ of the force generated by first portions 212-1 is exerted on ions 300 within ion guide 100 in a direction along the ion path (e.g., along the Z axis or central axis 210). Second component F₂ of the force generated by first portions 212-1 is exerted on ions 300 within ion guide 100 in direction 214 perpendicular to the ion path (e.g., along the X axis, from first outer edge 216-1 toward central axis 210).

Likewise, due to the angled orientation of the outer edge portion of second portions 212-2 at second angle α₂ relative to the ion path, third component F₃ of the force generated by second portions 212-2 is exerted on ions 300 within ion guide 100 in a direction along the ion path (e.g., along the Z axis or central axis 210). Fourth component F₄ of the force generated by second portions 212-2 is exerted on ions 300 within ion guide 100 in direction 214 perpendicular to the ion path (e.g., along the X axis from second outer edge 216-2 toward central axis 210). Accordingly, third component F₃ is exerted in the same direction as first component F₁ and fourth component F₄ is exerted opposite to second component F₂.

In some examples, such as when first portions 212-1 and second portions 212-2 are symmetrical, a magnitude of first component F₁ of the force is equal to a magnitude of third component F₃ and a magnitude of second component F₂ is equal to a magnitude of fourth component F₄ (e.g., to direct ions 300 toward central axis 210 of the ion path). Alternatively, a magnitude of one or more components F of the forces may differ, such as to guide ions 300 at a location offset from central axis 210.

When first electrodes 102-1 and second electrodes 102-2 receive RF trapping voltages as described above, the forces generated by first electrodes 102-1 and second electrodes 102-2 further include a fifth component F₅ and a sixth component F₆, respectively, in a direction away from (e.g., orthogonal to) first surface 104-1 (e.g., the Y axis, toward second surface 104-2).

Third electrodes 102-3 and fourth electrodes 102-4 on second surface 104-2 generate corresponding forces when third electrodes 102-3 and fourth electrodes 102-4 receive voltages according to one of the voltage schemes described above. For example, when third electrodes 102-3 and fourth electrodes 102-4 receive RF traveling wave voltages or DC gradient voltages as described above, due to the angled orientation of first portions 212-1 and second portions 212-2 of third electrodes 102-3 and fourth electrodes 102-4, third electrodes 102-3 and fourth electrodes 102-4 likewise generate a force having one or more components in the direction along the ion path (e.g., along the Z axis or central axis 210) and in direction 214 perpendicular to the ion path (e.g., along the X axis toward central axis 210). When third electrodes 102-3 and fourth electrodes 102-4 receive RF trapping voltages as described above, the force generated by third electrodes 102-3 and fourth electrodes 102-4 further includes one or more components in a direction away from (e.g., orthogonal to) second surface 104-2 (e.g., the Y axis, toward first surface 104-1) and opposite of the fifth component F₅ and the sixth component F₆ of the force generated by first electrodes 102-1 and second electrodes 102-2.

In some examples, when electrodes 102 of ion guide 100 receive RF voltages (e.g., RF trapping voltages and/or RF traveling wave voltages) as described above, electrodes 102 generate an electric field that exerts electrostatic forces (e.g., having one or more components F) to confine ions 300 within the ion path. To illustrate, when first electrodes 102-1 receive first RF voltages, second electrodes 102-2 receive second RF voltages, third electrodes 102-3 receive third RF voltages, and fourth electrodes 102-4 receive fourth RF voltages, first electrodes 102-1, second electrodes 102-2, third electrodes 102-3, and fourth electrodes 102-4 generate a confinement field 400, such as an RF confinement field, to confine ions 300 within ion guide 100. For example, at first side 206 and second side 208 of ion containment space 106, opposing outer edge portions of electrodes 102 generate outer edges of confinement field 400.

Referring now to FIGS. 3B and 4, at first side 206 of ion containment space 106, first portions 212-1 of first electrodes 102-1 and second electrodes 102-2 on first surface 104-1 are positioned opposite first portions 212-1 of third electrodes 102-3 and fourth electrodes 102-4 on second surface 104-2, respectively, to generate a first edge 402 of confinement field 400 at first side 206 of ion containment space 106. First edge 402 of confinement field 400 includes trapping potentials that inhibit ions 300 from moving toward first side 206 and escaping ion containment space 106 at first side 206. At second side 208 of ion containment space 106, second portions 212-2 of first electrodes 102-1 and second electrodes 102-2 on first surface 104-1 are positioned opposite second portions 212-1 of third electrodes 102-3 and fourth electrodes 102-4 on second surface 104-2, respectively, to generate a second edge 404 of confinement field 400 at second side 208 of ion containment space 106. Second edge 404 of confinement field 400 includes trapping potentials that inhibit ions 300 from moving toward second side 208 and escaping ion containment space 106 at second side 208.

Additionally, when ions 300 are introduced into ion containment space 106, forces generated by first electrodes 102-1 and second electrodes 102-2 on first surface 104-1 inhibit movement of ions 300 toward first surface 104-1 in the −Y direction and forces generated by third electrodes 102-3 and fourth electrodes 102-4 on second surface 104-2 inhibit movement of ions 300 toward second surface 104-2 in the +Y direction. First edge 402 of confinement field 400 inhibits movement of ions 300 toward first side 206 in the −X direction and second edge 404 of confinement field 400 inhibit movement of ions 300 toward second side 208 in the +X direction.

With this configuration, electrodes 102 may receive RF voltages and generate confinement field 400 to contain ions 300 within ion containment space 106. Such a confinement field 400 may be generated without using separate guard electrodes for generating a DC confinement field. For example, ion guide 100 may not include guard electrodes extending along a side of the ion path that are configured to generate a DC confinement field when supplied with a DC voltage, thereby simplifying design and construction of ion guide 100.

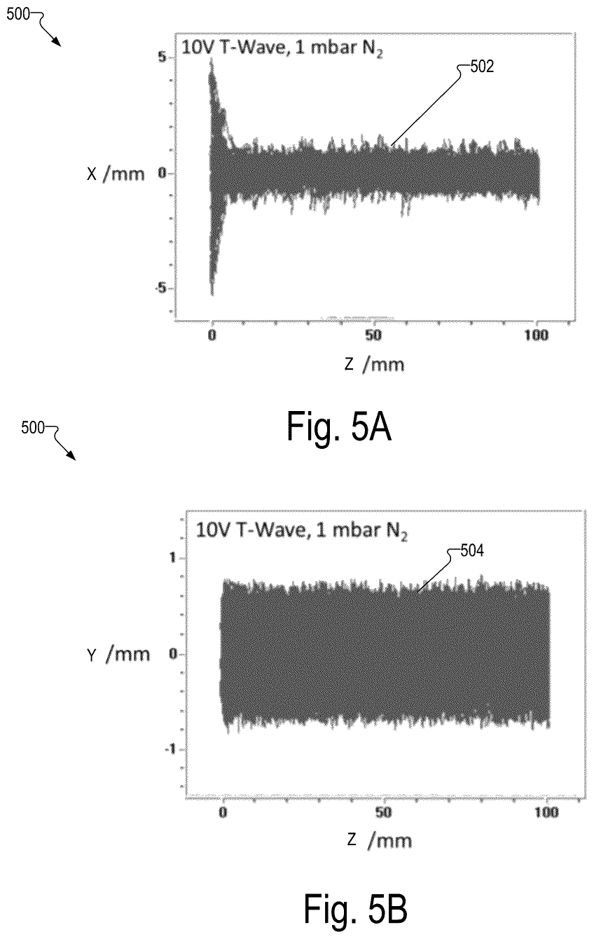

FIGS. 5A and 5B show results of a simulation 500 of illustrative ion trajectories of ions 300 within ion guide 100 when electrodes 102 receive RF voltages. In simulation 500, first surface 104-1 and second surface 104-2 are spaced about three millimeters (mm) apart. A three-megahertz (MHz) two-hundred volt (V) RF trapping voltage is applied to alternating electrodes 102 of ion guide 100 and a superimposed four-phase two hundred kilohertz (kHz) RF traveling wave voltage is also applied to electrodes 102 with a varying amplitude. The pressure within ion guide 100 is also varied.

FIG. 5A shows an illustrative ion trajectory 502 of simulation 500 along the X axis and Z axis. As shown, the RF voltages applied to electrodes 102 of ion guide 100 apply a 10V traveling wave potential, at one millibar pressure, simultaneously along the Z axis (e.g., the ion path) and the X axis (e.g., direction 214 perpendicular to the ion path), which propels ions 300 in the Z direction along the ion path and pushes ions 300 in the X direction (e.g., toward central axis 210) perpendicular to the ion path to confine ions 300 along the X direction within the ion path. In simulation 500, a 10 mm wide incident ion packet collapses to an about 2 mm wide ion beam. FIG. 5B shows an illustrative ion trajectory 504 of simulation 500 along the Y axis and Z axis. As shown, the 10V traveling wave potential, at one millibar pressure, applied by electrodes 102 further confines ions 300 along the Y axis (e.g., between first surface 104-1 and second surface 104-2) as ions 300 are propelled along the Z axis (e.g., the ion path). Thus, the design of electrodes 102 as taught herein can provide an ion guide 100 with a fairly wide spatial acceptance (e.g., 10 mm ion beam along the X axis at ion entrance) that nevertheless produces a narrow ion beam (e.g., 2 mm along the X axis at ion exit).

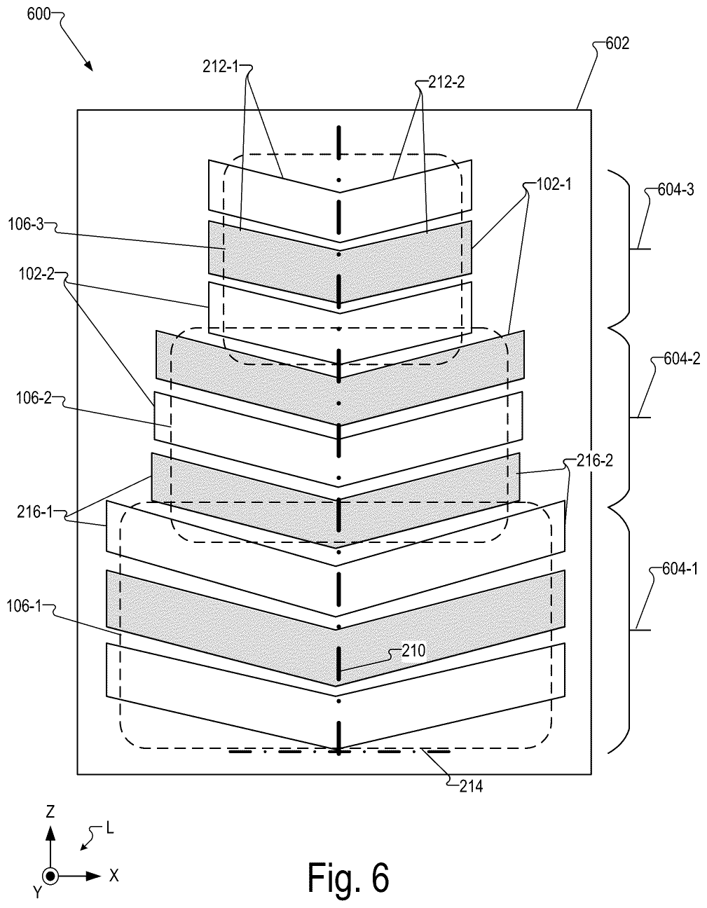

In the examples described above, transporting and confining ions within ion guide 100 is achieved by using electrodes 102 having similar V-shapes. However, the transporting and confining of ions may be achieved by using other electrode shapes. Examples of alternative electrode shapes will now be described with reference to FIGS. 6-9.

FIG. 6 shows a configuration 600 of electrodes 102 on a surface 602. Surface 602 may implement first surface 104-1 and/or second surface 104-2 of ion guide 100. In FIG. 6, each electrode 102 has a V-shape in which at least outer edge portions of electrodes 102 are arranged on surface 602 at angles oblique to both the ion path (e.g., Z axis) and direction 214 perpendicular to the ion path (e.g., X axis). As shown, electrodes 102 are arranged along the longitudinal axis of ion containment space 106 to form the ion path having a linear central axis 210. Each electrode 102 has a span that includes a distance along direction 214 from first outer edge 216-1 to second outer edge 216-2 of each electrode 102. As shown, the span of electrodes 102 along direction 214 perpendicular to the ion path decreases along the ion path (e.g., toward central axis 210) to form an ion funnel.

For example, electrodes 102 are formed in a first arrangement 604-1, a second arrangement 604-2, and a third arrangement 604-3 such that the span of electrodes 102 included in second arrangement 604-2 is smaller than the span of electrodes 102 included in first arrangement 604-1 and the span of electrodes 102 included in third arrangement 604-3 is smaller than the span of electrodes 102 included in second arrangement 604-2, and so on. To illustrate, outer edges 216 of electrodes 102 included in second arrangement 604-2 are positioned within outer edges 216 of electrodes 102 included in first arrangement 604-1 toward central axis 210 of the ion path and outer edges 216 of electrodes 102 included in third arrangement 604-3 are positioned within outer edges 216 of electrodes 102 included in second arrangement 604-2 toward central axis 210 of the ion path.

Accordingly, electrodes 102 of first arrangement 604-1 are arranged within a first ion containment space 106-1, electrodes 102 of second arrangement 604-2 are arranged within a second ion containment space 106-2 that is narrower than first ion containment space 106-1 in the X direction, and electrodes 102 of third arrangement 604-3 are arranged within a third ion containment space 106-3 that is narrower than second ion containment space 106-2 in the X direction. At least a portion of arrangements 604 and/or ion containment spaces 106 are connected to allow ions to pass through arrangements 604 and/or ion containment spaces 106. Because arrangements 604 of electrodes 102 narrow along the ion path, ions are increasingly guided toward central axis 210 along the ion path when electrodes 102 receive voltages according to one of the voltage schemes described above. While the illustrated example shows three electrodes 102 arranged in three arrangements 604, any suitable number of electrodes 102 and/or arrangements 604 may be used.

An ion guide may be formed by positioning two surfaces 602 opposite one another such as to align a central axis 210 of one surface 602 with a central axis 210 of another surface 602.

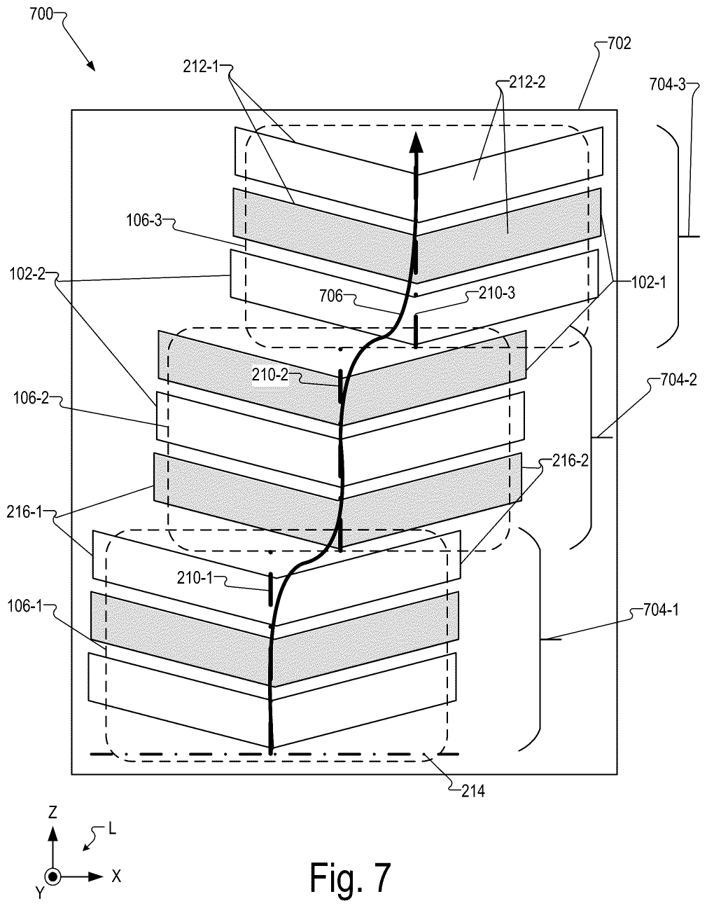

FIG. 7 shows another alternative configuration 700 of electrodes 102 on a surface 702. Surface 702 may implement first surface 104-1 and/or second surface 104-2 of ion guide 100. In FIG. 7, each electrode 102 has a V-shape in which at least outer edge portions of electrodes 102 are arranged on surface 702 at angles oblique to both the ion path (e.g., Z axis) and direction 214 perpendicular to the ion path (e.g., X axis). As shown, electrodes 102 are offset in direction 214 perpendicular to the ion path such that portions of the ion path are nonlinear.

For example, electrodes 102 are arranged in a first arrangement 704-1 within first ion containment space 106-1 to form a first ion path having a first central axis 210-1, a second arrangement 704-2 within second ion containment space 106-2 to form a second ion path having a second central axis 210-2, and a third arrangement 704-3 within third ion containment space 106-3 to form a third ion path having a third central axis 210-3. Electrodes 102 included in second arrangement 704-2 are offset in the X direction relative to electrodes 102 included in first arrangement 704-1 such that second central axis 210-2 is offset from first central axis 210-1 in the X direction. Electrodes 102 included in third arrangement 704-3 are offset in the X direction relative to electrodes 102 included in second arrangement 704-2 such that third central axis 210-3 is offset from second central axis 210-2 in the X direction, and so on. While the illustrated example shows second arrangement 704-2 and third arrangement 704-3 offset in the same +X direction, one or both of second arrangement 704-2 and third arrangement 704-3 may be offset in other directions, such as the −X direction.

At least a portion of arrangements 704 and/or ion containment spaces 106 are connected to allow ions to pass through arrangements 704 and/or ion containment spaces 106. Because arrangements 704 of electrodes 102 shift in the +X direction along the ion path, ions are increasingly guided in the +X direction when electrodes 102 receive RF voltages. For example, an illustrative ion trajectory 706 is shown that shifts in the +X direction as ion trajectory 706 passes from first arrangement 704-1 of electrodes, through second arrangement 704-2 and third arrangement 704-3. While the illustrated example shows three electrodes 102 arranged in three arrangements 704, any suitable number of electrodes 102 and/or arrangements 704 may be used.

An ion guide may be formed by positioning two surfaces 702 opposite one another, such as to align central axes 210 of one surface 702 with central axes 210 of another surface 702.

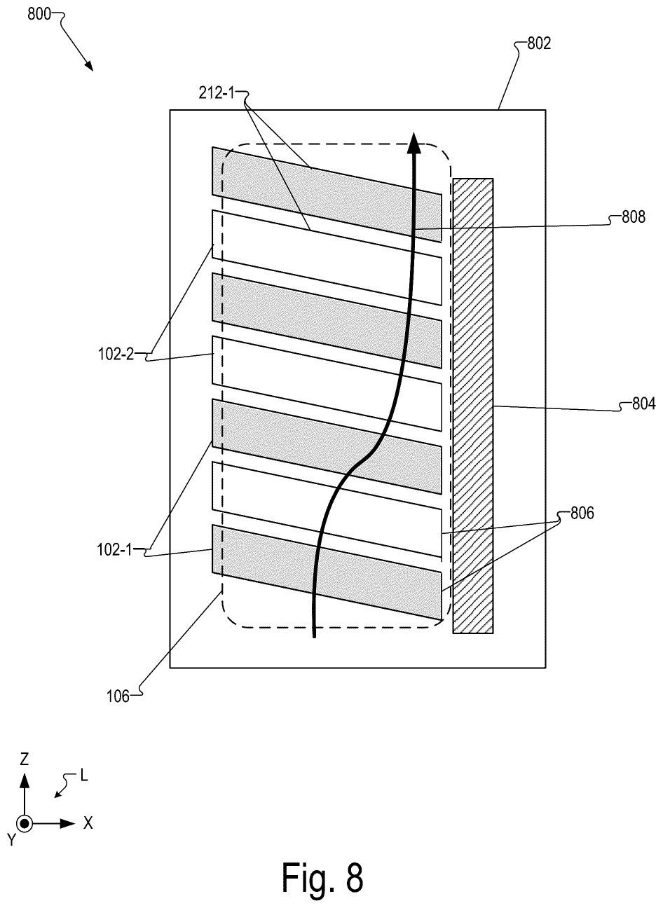

FIG. 8 shows another alternative configuration 800 of electrodes 102 on a surface 802. Surface 802 may implement first surface 104-1 and/or second surface 104-2 of ion guide 100. In FIG. 8, each electrode 102 includes only first portions 212-1 (e.g., does not include second portions 212-2) such that first portions 212-1 are sequentially arranged on surface 802 longitudinally along the ion path with at least the outer edge portions arranged at an angle oblique to both the ion path (e.g., Z axis) and the direction perpendicular to the ion path (e.g., X axis).

Configuration 800 further comprises a guard electrode 804 extending along a side of the ion path (e.g., along inner edges 806 of electrodes 102). Guard electrode 804 is configured to receive a DC voltage (e.g., a DC trapping voltage). When guard electrode 804 receives the DC voltage, guard electrode 804 applies a DC field in the direction perpendicular to the ion path (e.g., −X direction) away from guard electrode 804 and inner edges 806 of electrodes 102. Accordingly, when electrodes 102 receive RF traveling wave voltages, electrodes 102 exert a force simultaneously along the ion path and the direction perpendicular to the ion path (e.g., +X direction) toward guard electrode 804, while the DC field is applied by guard electrode 804 in the opposite direction perpendicular to the ion path (e.g., −X direction). In some examples, the force exerted by electrodes 102 along the direction perpendicular to the ion path (e.g., +X direction) has a higher magnitude than the DC field applied by guard electrode 804, such that ions are guided toward guard electrode 804 along the ion path. For example, an illustrative ion trajectory 808 is shown that curves toward guard electrode 804 along the ion path. In other examples, the force exerted by electrodes 102 along the direction perpendicular to the ion path (e.g., +X direction) has an equal magnitude to the DC field applied by guard electrode 804 such that ions experience no net force and are not urged along either X direction. Such examples can be used alone or in combination with the above examples where the forces are imbalanced within a single configuration 800 (i.e., at different portions of the same configuration 800). An ion guide may be formed by positioning two surfaces 802 opposite one another such as to align electrodes 102 and guard electrodes 804. While FIG. 8 shows one guard electrode, the ion guide may include any suitable number of guard electrodes sequentially positioned along the ion path.

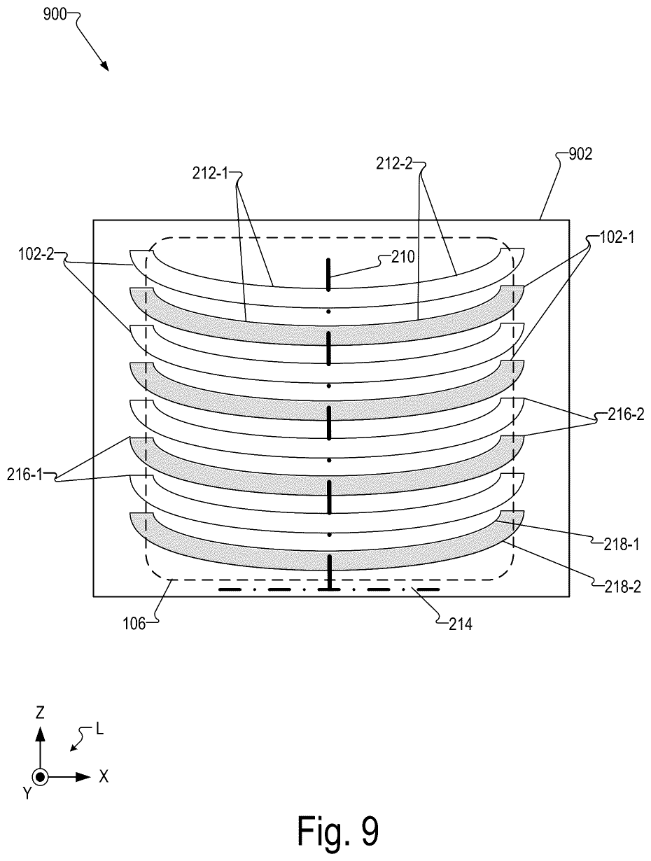

FIG. 9 shows another alternative configuration 900 of electrodes 102 on a surface 902. Surface 902 may implement first surface 104-1 and/or second surface 104-2 of ion guide 100. In FIG. 9, first electrodes 102-1 and second electrodes 102-2 are curved in an arcuate configuration. For example, first portions 212-1 of electrodes 102 are curved outwardly from central axis 210 toward first outer edges 216-1 (e.g., in the −X direction) along the ion path (e.g., Z axis) such that at least the outer edge portions of first portions 212-1 are oriented at an angle oblique to both the ion path and direction 214 perpendicular to the ion path. For example, an imaginary tangent line (not shown) at a point on a side edge 218 of an outer edge portion of first portion 212-1 is oblique to the ion path (e.g., central axis 210) and the direction 214 perpendicular to the ion path. Likewise, second portions 212-2 of electrodes 102 are curved outwardly from central axis 210 toward second outer edges 216-2 (e.g., in the +X direction) along the ion path such that at least the outer edge portions of second portions 212-2 are oriented at an angle oblique to both the ion path and direction 214 perpendicular to the ion path. For example, an imaginary tangent line (not shown) at a point on a side edge 218 of an outer edge portion of second portion 212-2 is oblique to the ion path (e.g., central axis 210) and the direction 214 perpendicular to the ion path. Accordingly, electrodes 102 have a U-shape. An ion guide may be formed by positioning two surfaces 902 opposite one another, such as with the central axes 210 aligned with one another.

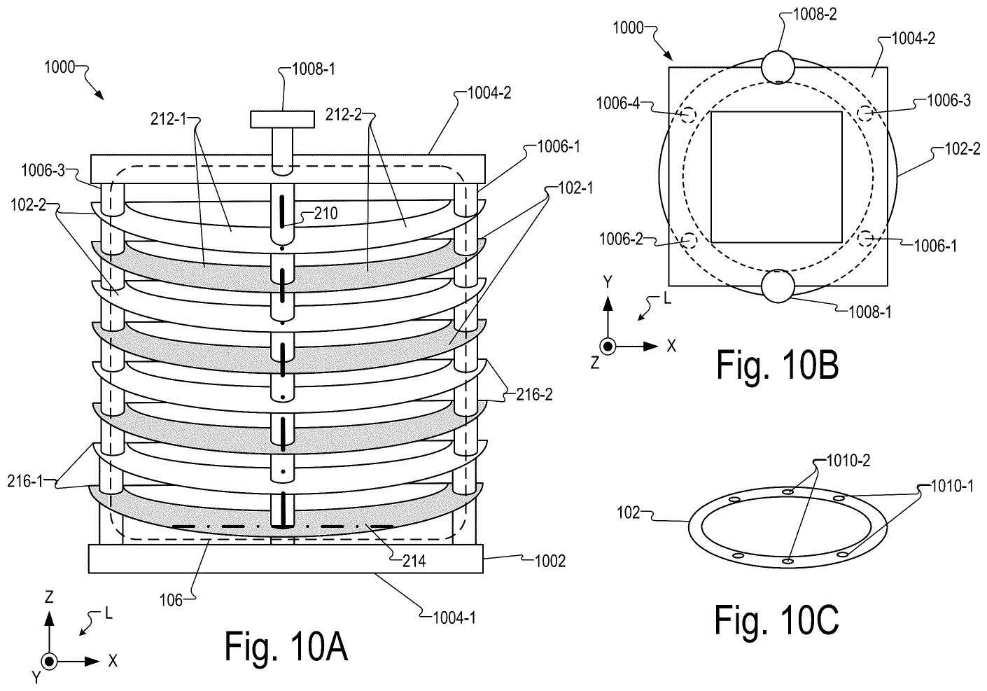

In the examples described above, transporting and confining ions within ion guide 100 is achieved by using electrodes 102 arranged on surfaces (e.g., surfaces 104, surfaces 602, surfaces 702, surfaces 802, or surfaces 902). However, the transporting and confining of ions may be achieved by using other arrangements of electrodes 102. An example of an alternative electrode arrangement will now be described with reference to FIGS. 10A and 10B.

FIGS. 10A and 10B show various views of an illustrative ion guide 1000. FIG. 10A shows a side view of ion guide 1000. FIG. 10B shows a plan view of ion guide 1000. Ion guide 1000 is similar to ion guide 100 except that, in ion guide 1000, the plurality of first electrodes 102-1 and the plurality of second electrodes 102-2 are arranged on an ion guide form 1002 instead of a surface (e.g., surface 104, surface 602, surface 702, surface 802, or surface 902). For example, first electrodes 102-1 and second electrodes 102-2 include ring (e.g., annular) electrodes arranged along the ion path (e.g., Z axis) in an alternating pattern, as in a stacked ring ion guide. A portion of each electrode 102 is bent in the Z-direction (e.g., out of an X-Y plane) such that at least a portion of each electrode is positioned at an angle oblique to both the ion path (e.g., central axis 210) and direction 214 perpendicular to the ion path. Accordingly, when confinement voltages are received by electrodes 102, electrodes 102 are configured to guide ions along the ion path (e.g., through ion guide form 1002) and confine the ions in direction 214 perpendicular to the ion path (e.g., within ion guide form 1002). Electrodes 102 may be bent by any suitable method. For example, electrodes 102 may be manufactured in the bent configuration and/or electrodes 102 may be bent by ion guide form 1002.

An illustrative example of bending electrodes 102 using ion guide form 1002 is shown in FIGS. 10A-10C. As shown, ion guide form 1002 includes a first frame 1004-1, a second frame 1004-2, and a plurality of supports 1006 (e.g., supports 1006-1 through 1006-4) extending between first frame 1004-1 and second frame 1004-2. Ion guide form 1002 further includes one or more movable members 1008 (e.g., movable members 1008-1 and 1008-2) extending between first frame 1004-1 and second frame 1004-2. For example, movable members 1008 are translatable relative to first frame 1004-1 and/or second frame 1004-2 along the ion path (e.g., Z axis). In some examples, the one or more movable members 1008 may be implemented by a set screw or other suitable movable fastener.

First electrodes 102-1 and second electrodes 102-2 are arranged on ion guide form 1002 along the ion path (e.g., Z axis) in an alternating pattern. Referring to FIG. 10C, which shows a perspective view of an electrode 102 of ion guide 1000, each electrode 102 may be implemented by an electrode having a ring (e.g., circular, elliptical, oval, etc.) shape, though other suitable shapes (e.g., square, rectangular, triangular, etc.) may be used. In the case of an oval shape, the narrower distance along the minor axis of the oval profile can better focus the height of the ion beam. Each electrode 102 further includes a plurality of first openings 1010-1 and a plurality of second openings 1010-2 extending through electrodes 102. First openings 1010-1 are configured to receive supports 1006 of ion guide form 1002 therethrough and second openings 1010-2 are configured to receive movable members 1008 therethrough.

Referring to FIGS. 10A and 10B, electrodes 102 are assembled on supports 1006 of ion guide form 1002 such that one or more portions of electrodes 102 are coupled to supports 1006 and one or more other portions of electrodes 102 are coupled to the one or more movable members 1008. The one or more movable members 1008 are translatable along the ion path (e.g., in the −Z direction) relative to supports 1006 so as to bend the one or more other portions of electrodes 102 coupled to the one or more movable members 1008 toward first frame 1004-1. Such translation of the one or more movable members 1008 positions at least the one or more portions of electrodes coupled to supports 1006 at an angle oblique to both the ion path (e.g., central axis 210) and direction 214 perpendicular to the ion path. Accordingly, first electrodes 102-1 and second electrodes 102-2 are bent in an arcuate configuration. When RF voltages are received by electrodes 102, electrodes 102 are configured to guide ions along the ion path through ion guide form 1002 and confine the ions in direction 214 perpendicular to the ion path within supports 1006 of ion guide form 1002.

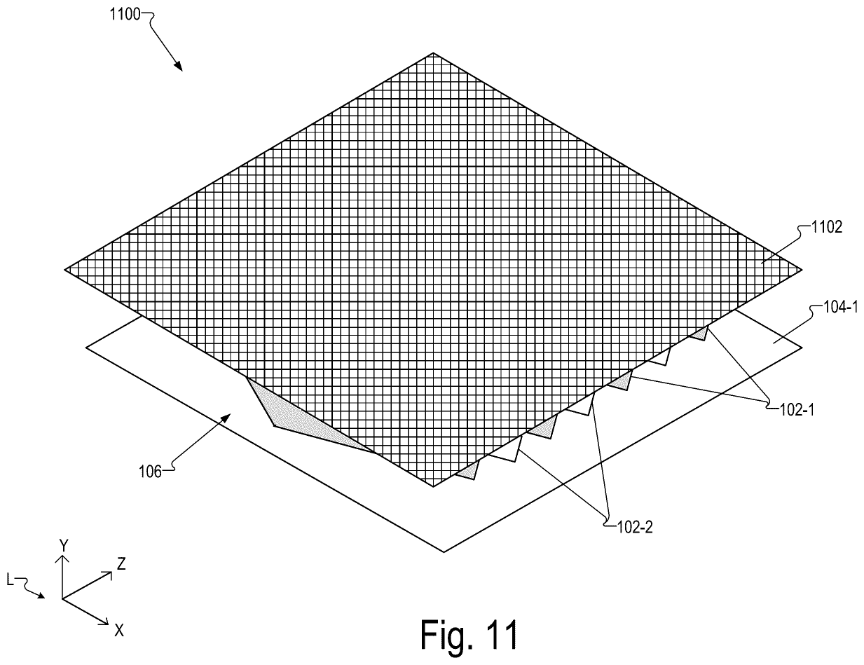

FIG. 11 shows a perspective view of another illustrative ion guide 1100 that is similar to ion guide 100 except that ion guide 1100 includes a counter electrode 1102 (instead of second surface 104-2) positioned opposite first surface 104-1. As shown, counter electrode 1102 is arranged along the ion path opposite of first electrodes 102-1 and electrodes 102-2. Counter electrode 1102 is configured to generate an electric field to repel ions within the ion path away from counter electrode 1102 (e.g., in the −Y direction) when counter electrode 1102 receives a DC voltage.

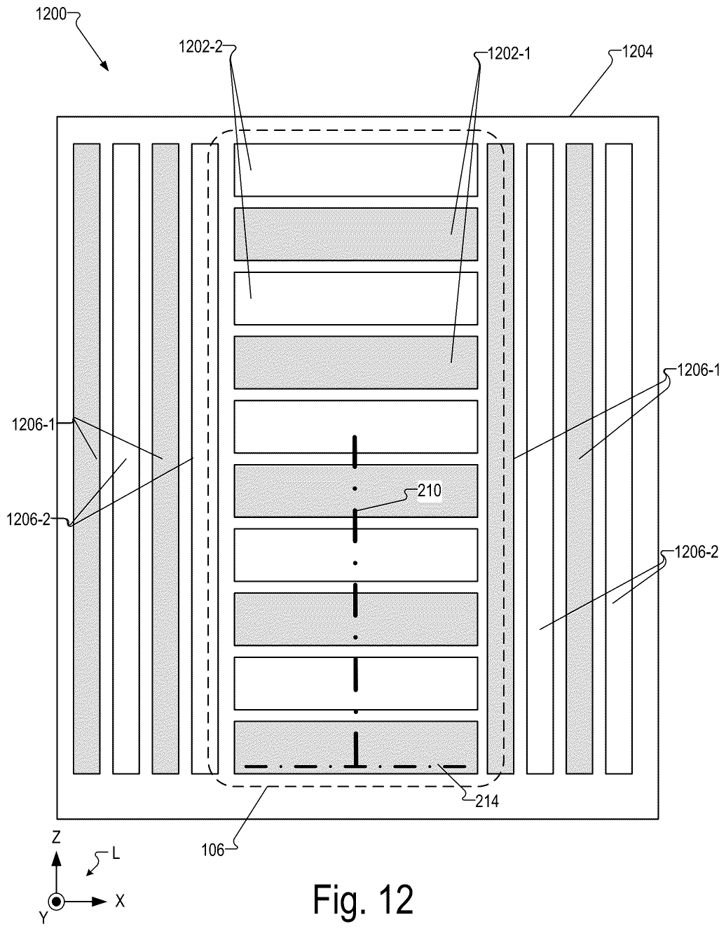

FIG. 12 shows another alternative configuration 1200 of electrodes 1202 arranged on a surface 1204. Surface 1204 may implement first surface 104-1 and/or second surface 104-2 of ion guide 100. In FIG. 12, a plurality of elongate first electrodes 1202-1 and a plurality of elongate second electrodes 1202-2 are arranged on surface 1204 along ion path. Electrodes 1202 are similar to electrodes 102 except that electrodes 1202 are arranged on surface 1204 in direction 214 perpendicular to the ion path (e.g., the Z axis). A plurality of elongate first guard electrodes 1206-1 and a plurality of elongate second guard electrodes 1206-2 are further arranged on surface 1204 along each side of the ion path. For example, guard electrodes 1206 extend along the outer edges of electrodes 1202 in the Z direction.

Electrodes 1202 and guard electrodes 1206 are configured to receive voltages and generate a force that guides ions along the ion path (e.g., in the Z direction) and within the ion path (e.g., in the X direction). For example, the guard electrodes 1206 can be configured to receive voltages that generate inwardly-directed (i.e., towards the central axis 210) traveling waves that will tend to urge ions towards the central axis 210. In some examples, first electrodes 1202-1 and first guard electrodes 1206-1 are configured to receive the same first voltages and second electrodes 1202-2 and second guard electrodes 1206-2 are configured to receive the same second voltages that are phase shifted relative to the first voltages. An ion guide may be formed by positioning two surfaces 1204 opposite one another, such as with central axes 210 aligned.

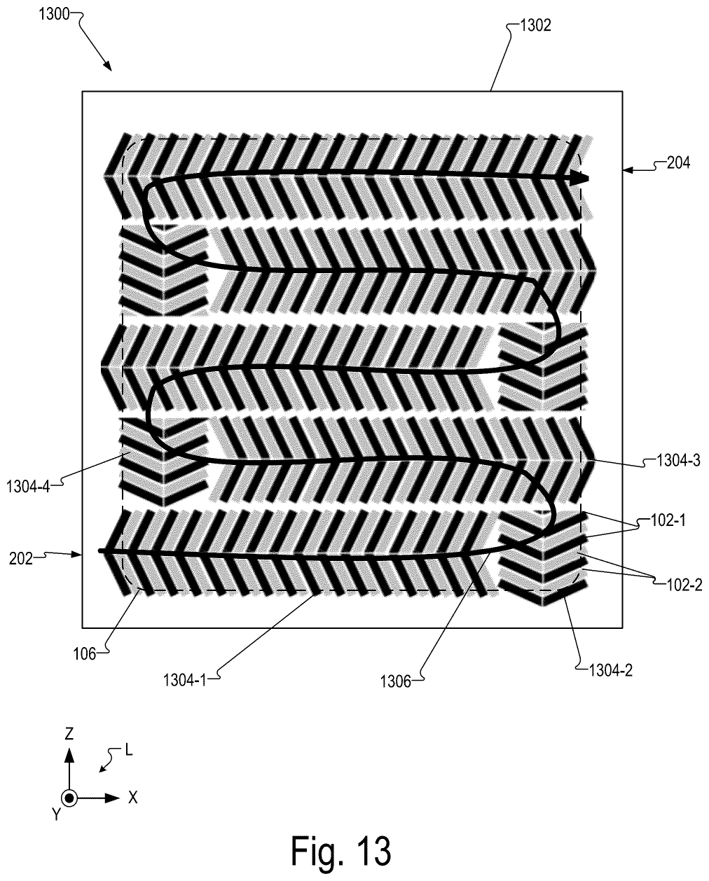

FIG. 13 shows another alternative configuration 1300 of electrodes 102 arranged on a surface 1302. Surface 1302 may implement first surface 104-1 and/or second surface 104-2 of ion guide 100. In FIG. 13, first electrodes 102-1 and second electrodes 102-2 are arranged along a first portion 1304-1 extending in a first direction (e.g., the +X direction), a second portion 1304-2 extending in a second direction (e.g., the +Z direction) that is different than the first direction, a third portion 1304-3 extending in a third direction (e.g., the −X direction) that is different than the second direction, and a fourth portion 1304-4 extending in a fourth direction (e.g., the +Z direction) that is different than the third direction. As shown, each portion 1304 is linear and an angle between the directions of each portion 1304 is about 90 degrees such that the first and third directions are opposite relative to each other. With this configuration, the ion path formed by portions 1304 folds back on itself four times, though a different number of folds can be provided. Moreover, portions 1304 may have other shapes (e.g., curved, nonlinear, etc.) and/or orientations. To illustrate, an angle between the directions of each portion 1304 may be greater than about 90 degrees or greater than about 120 degrees such that portions 1304 do not fold fully back on themselves.

Portions 1304 of electrodes 102 are arranged such that first portion 1304-1 forms a first ion path extending in the first direction, second portion 1304-2 forms a second ion path connected to the first ion path and extending in the second direction, third portion 1304-3 forms a third ion path connected to the second ion path and extending in the third direction, and fourth portion 1304-4 forms a fourth ion path connected to the third ion path and extending in the fourth direction. For example, FIG. 13 shows an illustrative circuitous ion trajectory 1306 of ions being guided along the ion paths formed by portions 1304 from entrance aperture 202 to exit aperture 204 when electrodes 102 receive confinement voltages.

As shown in FIG. 13, each portion 1304 is arranged on surface 1302 within the same plane (e.g., the XZ plane) such that the first, second, third, and fourth directions extend within the same plane. Additionally, the ion path formed by the first, second, third, and fourth ion paths of portions 1304 is circuitous in two spatial dimensions (e.g., along the X direction and the Z direction). The circuitous ion path enables long ion paths, which can be useful in ion mobility separation applications where, for example, the resolving power of the separation process can increase with the square root of the length of the ion path.

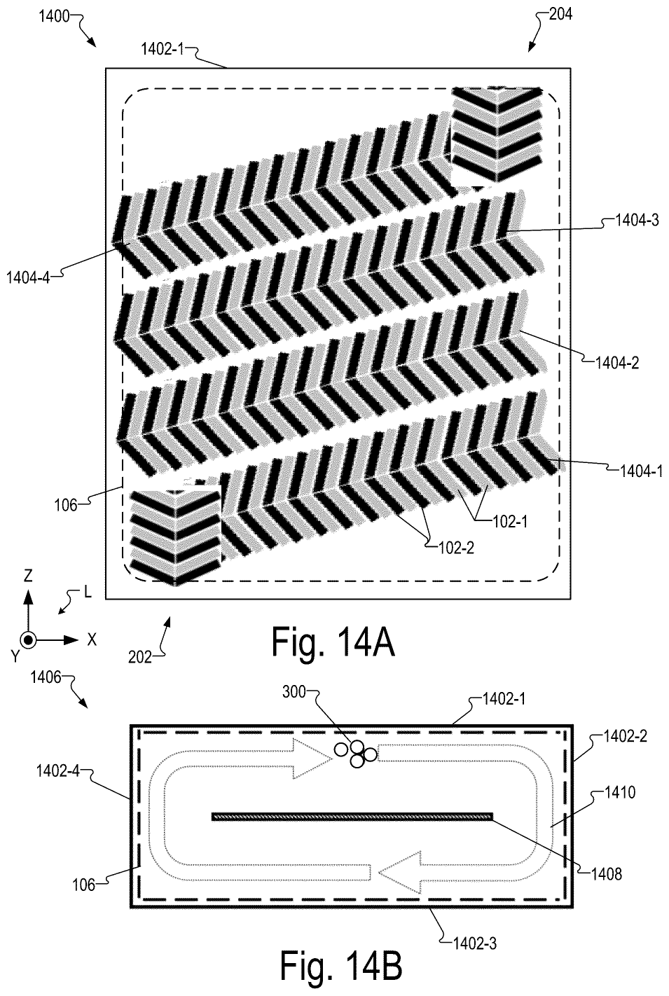

In some examples, the ion path may be circuitous in three spatial dimensions (e.g., along the X direction, Y direction, and Z direction). To illustrate, FIG. 14A shows another alternative configuration 1400 of electrodes 102 arranged on a first surface 1402-1. First surface 1402-1 may implement first surface 104-1 and/or second surface 104-2 of ion guide 100. In FIG. 14A, first electrodes 102-1 and second electrodes 102-2 include a first portion 1404-1, a second portion 1404-2, a third portion 1404-3, and a fourth portion 1404-4 each linearly aligned along first surface 1402-1 in substantially the same direction. As shown, each portion 1404 is positioned at an angle between the X axis and the Z axis, such as between about 0 degrees and about 90 degrees, between about 30 degrees and 60 degrees, or about 45 degrees.

FIG. 14B shows a plan view of an ion guide 1406 that implements configuration 1400 of electrodes 102. As shown, ion guide 1406 includes a plurality of surfaces 1402 (e.g., surfaces 1402-1 through 1402-4) that are positioned relative to each other such as to connect the ions paths formed by electrodes 102 arranged on surfaces 1402. For example, surfaces 1402 are positioned relative to each other to align first portions 1404-1 of electrodes 102 on surfaces 1402 with each other, second portions 1404-2 of electrodes 102 with each other, third portions 1404-3 of electrodes 102 with each other, and fourth portions 1404-4 of electrodes 102 with each other. Such a configuration connects the ion paths formed by portions 1404 extending in different planes to provide a continuous helical ion path within ion guide 1406. FIG. 14B shows four surfaces 1402 positioned relative to each other in a rectangular configuration, though any other suitable number of surfaces 1402 may be used to form any other suitable configuration.

Ion guide 1406 further includes a counter electrode 1408 extending centrally within ion guide 1406 opposite each surface 1402. Counter electrode 1408 is configured to receive voltages (e.g., RF voltages and/or DC voltages) to repel ions 300 within ion guide 1406 away from counter electrode 1408 toward surfaces 1402. Accordingly, when electrodes 102 and counter electrode 1408 receive voltages, ions 300 are guided in a helical configuration, as shown by arrows 1410, through ion guide 1406 from entrance aperture 202 to exit aperture 204.

In some examples, an ion guide (e.g., ion guide 100, ion guide 1000, ion guide 1100, or ion guide 1406) is incorporated into an ion mobility separator and/or a mass spectrometry system that includes a mass analyzer. For example, the ion guide can be used to add one or both of ion mobility information to a mass analysis and/or to work in a conjoined fashion with a quadrupole mass filter (or other mass filter) to limit the proportion of ions becoming deposited on the quadrupole rods.

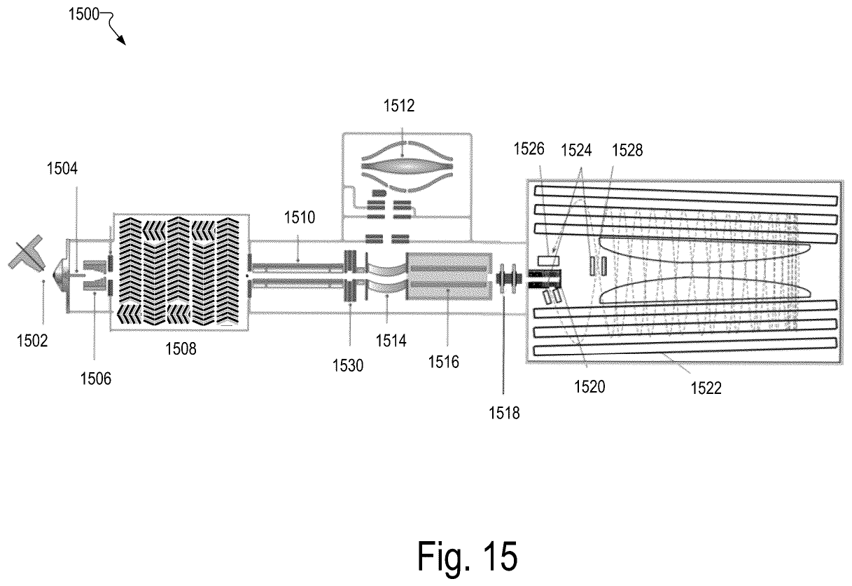

To illustrate, FIG. 15 shows a mass spectrometry system 1500 that incorporates an ion guide according to the present disclosure. In use, ions are generated from a sample by an electrospray ion source 1502 and enter a vacuum system through a capillary 1504, to be captured within an ion funnel 1506. In this case, ion funnel 1506 may act as an accumulating device for pulsed introduction to an ion mobility separator 1508, but such functionality may also be incorporated into ion mobility separator 1508 itself with a gate electrode. Ions are then introduced to ion mobility separator 1508 and make their way through a winding ion path (e.g., provided by ion guide 100, ion guide 1000, ion guide 1100, or ion guide 1406), becoming separated by mobility (and substantially by m/z and charge state). As ions of different mobility emerge to a quadrupole mass filter 1510, quadrupole mass filter 1510 transmits ions only at a target ion m/z within a mobility window, based on an understanding of the analyte type and the relationship between mobility and m/z. Selected ions are then optionally fragmented and sent to an orbital trapping analyzer 1512 or a multi-reflection-time-of-flight analyzer for mass analysis.

Mass spectrometry system 1500 of the illustrated example further includes a C-trap 1514, a fragmentation chamber 1516, a multipole ion guide 1518, and a multi-reflection time-of-flight analyzer incorporating an extraction trap 1520, opposing tilted ion mirrors 1522, deflectors 1524, a detector 1526, and a correcting stripe electrode 1528. An optional charge detector 1530 is provided to detect charged particles. A bypass to ion mobility separator 1508 is not shown in FIG. 15, but could be provided so that wide m/z range mass spectra could be recorded without the time and ion loss of ion mobility separator 1508.

Various modifications may be made to the apparatuses described herein. In some examples, electrodes 102 arranged on first surface 104-1 have a different configuration from electrodes 102 arranged on second surface 104-2. For example, electrodes 102 arranged on first surface 104-1 may have the configuration shown in FIG. 2 and electrodes 102 arranged on second surface 104-2 may have the configuration shown in FIG. 9 or 12.

In some examples, electrodes 102 arranged on first surface 104-1 and/or second surface 104-2 include a combination of different electrode shapes or configurations. For example, electrodes 102 arranged on first surface 104-1 and/or second surface 104-2 may include any combination of V-shaped electrodes 102 or U-shaped electrodes 102.

In the examples described above, electrode portions 212 are rectangular. However, electrode portions 212 may have any other shape as may suit a particular implementation (e.g., rounded, oval, irregular, etc.).

In the examples described above, first portions 212-1 are formed integrally with second portions 212-2. In other examples, first portions 212-1 and second portions 212-2 are formed separately but are electrically connected (e.g., by a via, a trace, a wire, a relay, etc.) to receive the same RF voltages.

In the examples described above, electrodes 102 are arranged to form a linear (straight) ion path. In other examples, electrodes 102 are arranged to form a non-linear ion path. For example, the ion path may include one or more bends, turns, curves, and/or angles. Moreover, the ion guides described herein may include multiple ion paths and one or more junctions or intersections with other ion paths.

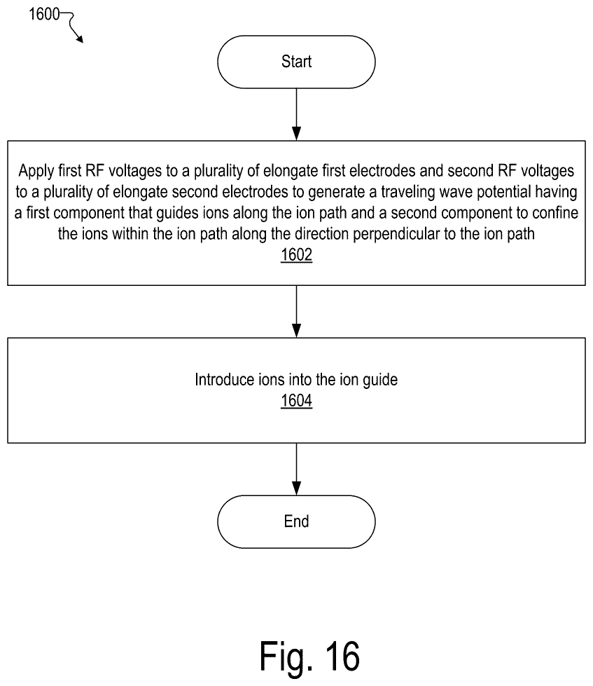

FIG. 16 shows a flowchart of an illustrative method 1600 of guiding ions. While FIG. 16 shows illustrative operations according to one example, other examples may omit, add to, reorder, and/or modify one or more operations of the method 1600 depicted in FIG. 16. Each operation of method 1600 depicted in FIG. 16 may be performed in any manner described herein.

At operation 1602, RF voltages are applied to electrodes included in an ion guide configured as described herein (e.g., ion guide 100, ion guide 1000, ion guide 1100, or ion guide 1406). The ion guide includes a plurality of elongate first electrodes and a plurality of elongate second electrodes arranged along an ion path in an alternating pattern. In some examples, the electrodes are arranged on a surface. The plurality of elongate first and second electrodes are configured as described herein. For example, at least an outer edge portion of each electrode included in the plurality of elongate first and second electrodes is arranged at an angle oblique to both the ion path and a direction perpendicular to the ion path. The RF voltages applied to the plurality of elongate first and second electrodes generate a traveling wave potential having a first component that guides ions along the ion path and a second component to confine the ions within the ion path along the direction perpendicular to the ion path. At operation 1604, ions are introduced into the ion guide. The traveling wave potential simultaneously guides the ions along the ion path and confines the ions within the ion path along the direction perpendicular to the ion path.

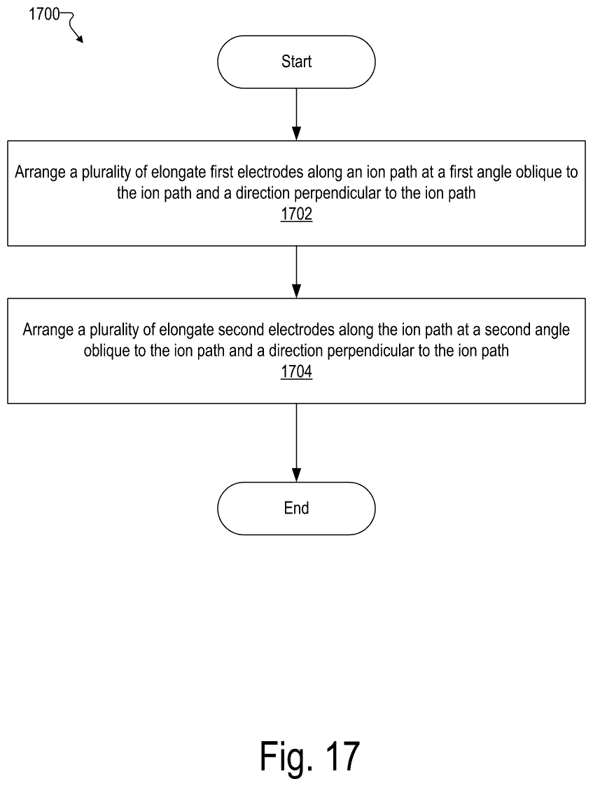

FIG. 17 shows a flowchart of an illustrative method 1700 of making an ion guide (e.g., ion guide 100, ion guide 1000, ion guide 1100, or ion guide 1406). While FIG. 17 shows illustrative operations according to one example, other examples may omit, add to, reorder, and/or modify one or more operations of the method 1700 depicted in FIG. 17. Each operation of method 1700 depicted in FIG. 17 may be performed in any manner described herein.

At operation 1702, a plurality of elongate first electrodes are arranged along an ion path at a first angle oblique to the ion path and a direction perpendicular to the ion path. The plurality of electrodes are arranged as described herein. For example, at least an outer edge portion of the electrodes included in the plurality of elongate first electrodes are positioned at the first oblique angle. In some examples, the electrodes have a V-shape or a U-shape. The electrodes may further be arranged on a surface.

At operation 1704, a plurality of elongate second electrodes are arranged along the ion path at a second angle oblique to the ion path and a direction perpendicular to the ion path. The plurality of electrodes are arranged as described herein. For example, at least an outer edge portion of the electrodes included in the plurality of elongate second electrodes are positioned at the second oblique angle. The second angle may be equal to and/or may vary relative to the first angle. In some examples, the electrodes have a V-shape or a U-shape. The electrodes may further be arranged on the surface in an alternating pattern with the plurality of elongate first electrodes.

In some examples, the surface is positioned opposite a second surface including a plurality of elongate third electrodes and fourth electrodes corresponding to the first electrodes and second electrodes and/or a counter electrode to define an ion containment space therebetween.

It will be recognized by those of ordinary skill in the art that while, in the preceding description, various illustrative examples have been described with reference to the accompanying drawings. It will, however, be evident that various modifications and changes may be made thereto, and additional examples may be implemented, without departing from the scope of the invention as set forth in the claims that follow. For example, certain features of one example described herein may be combined with or substituted for features of another example described herein. The description and drawings are accordingly to be regarded in an illustrative rather than a restrictive sense.

Advantages and features of the present disclosure can be further described by the following examples:
Example 1. An ion guide comprising: a plurality of elongate first electrodes arranged along an ion path and configured to receive first RF voltages; and a plurality of elongate second electrodes arranged along the ion path in an alternating pattern with the plurality of first electrodes and configured to receive second RF voltages that are phase-shifted with respect to the first RF voltages; wherein at least an outer edge portion of each of the plurality of elongate first electrodes and the plurality of elongate second electrodes is arranged at a first angle oblique to both the ion path and a direction perpendicular to the ion path.
Example 2. The ion guide of example 1, wherein, when the plurality of elongate first electrodes receive the first RF voltages and the plurality of elongate second electrodes receive the second RF voltages, the plurality of elongate first electrodes and the plurality of elongate second electrodes apply a traveling wave potential along the ion path and the direction perpendicular to the ion path to guide and confine the ions within the ion path.
Example 3. The ion guide of example 1, wherein the ion guide does not include guard electrodes extending along a side of the ion path and configured to generate a direct current (DC) confinement field when supplied with a DC voltage.
Example 4. The ion guide of example 1, wherein the plurality of elongate first electrodes and the plurality of elongate second electrodes are configured to receive DC voltages such that, when the plurality of elongate first electrodes and the plurality of elongate second electrodes receive the DC voltages, the plurality of elongate first electrodes and the plurality of elongate second electrodes apply a DC potential along the ion path.
Example 5. The ion guide of example 1, wherein each of the plurality of elongate first electrodes and the plurality of elongate second electrodes includes a first portion and a second portion that is substantially symmetrical to the first portion across a central axis of the ion path.
Example 6. The ion guide of example 1, further comprising: a plurality of elongate third electrodes arranged along the ion path opposite of the plurality of elongate first electrodes and configured to receive third RF voltages; and a plurality of elongate fourth electrodes arranged along the ion path opposite of the plurality of elongate second electrodes in an alternating pattern with the plurality of third electrodes and configured to receive fourth RF voltages that are phase-shifted with respect to the third RF voltages; wherein the plurality of elongate third electrodes and the plurality of elongate fourth electrodes are arranged at a second angle oblique to both the ion path and the direction perpendicular to the ion path.
Example 7. The ion guide of example 1, wherein the plurality of elongate first electrodes and the plurality of elongate second electrodes have a chevron configuration.
Example 8. The ion guide of example 1, further comprising a counter electrode arranged along the ion path opposite of the plurality of elongate first electrodes and the plurality of elongate second electrodes, wherein the counter electrode is configured to generate an electric field to direct ions within the ion path away from the counter electrode when the counter electrode receives a direct current (DC) voltage.
Example 9. The ion guide of example 1, wherein a span of the plurality of elongate first electrodes and the plurality of elongate second electrodes along the direction perpendicular to the ion path decreases along the ion path to form an ion funnel.
Example 10. The ion guide of example 1, further comprising a guard electrode extending along a side of the ion path and configured to receive a direct current (DC) voltage.
Example 11. The ion guide of example 1, wherein the plurality of elongate first electrodes and the plurality of elongate second electrodes are curved.
Example 12. The ion guide of example 11, wherein the plurality of elongate first electrodes and the plurality of elongate second electrodes include an assembly of ring electrodes bent in an arcuate configuration.
Example 13. The ion guide of example 1, wherein the plurality of elongate first electrodes and the plurality of elongate second electrodes are arranged on a printed circuit board (PCB).
Example 14. The ion guide of example 1, wherein the ion guide includes a first portion forming a first ion path extending in a first direction and a second portion forming a second ion path connected to the first ion path and extending in a second direction that is different than the first direction.
Example 15. The ion guide of example 14, wherein the first direction and the second direction extend within a same plane.
Example 16. The ion guide of example 14, wherein the first direction and the second direction extend along different planes.
Example 17. The ion guide of example 1, wherein the ion path is circuitous in two spatial dimensions or in three spatial dimensions.
Example 18. The ion guide of example 1, wherein the first angle of the plurality of elongate first electrodes and the plurality of elongate second electrodes relative to the ion path is between about 30 degrees and about 60 degrees.
Example 19. The ion guide of example 1, wherein the first angle of the plurality of elongate first electrodes and the plurality of elongate second electrodes relative to the ion path is about 45 degrees.
Example 20. The ion guide of example 1, wherein the plurality of elongate first electrodes and the plurality of elongate second electrodes have a V-shape or a U-shape.
Example 21. An ion mobility separator comprising the ion guide of example 1.
Example 22. A mass spectrometry system comprising a mass analyzer and the ion guide of example 1.
Example 23. An ion guide comprising: a plurality of elongate first electrodes arranged along an ion path and configured to receive first RF voltages; and a plurality of elongate second electrodes arranged along the ion path in an alternating pattern with the plurality of first electrodes and configured to receive second RF voltages that are phase-shifted with respect to the first RF voltages; wherein at least an outer edge portion of each of the plurality of elongate first electrodes and the plurality of elongate second electrodes is arranged at an angle relative to the ion path such that, when the plurality of elongate first electrodes receive first RF voltages and the plurality of elongate second electrodes receive second RF voltages, the plurality of elongate first electrodes and the plurality of elongate second electrodes exert a force having a first component along the ion path to guide ions along the ion path and a second component along the direction perpendicular to the ion path to confine ions within the ion path.
Example 24. The ion guide of example 23, wherein, when the plurality of elongate first electrodes receive the first RF voltages and the plurality of elongate second electrodes receive the second RF voltages, the plurality of elongate first electrodes and the plurality of elongate second electrodes generate a traveling wave potential simultaneously along the ion path and the direction perpendicular to the ion path.
Example 25. The ion guide of example 23, wherein, when the plurality of elongate first electrodes receive the first RF voltages and the plurality of elongate second electrodes receive the second RF voltages, the plurality of elongate first electrodes and the plurality of elongate second electrodes generate a confinement field without generating a direct current (DC) confinement field.
Example 26. The ion guide of example 23, wherein the plurality of elongate first electrodes and the plurality of elongate second electrodes are configured to receive DC voltages such that, when the plurality of elongate first electrodes and the plurality of elongate second electrodes receive the DC voltages, the plurality of elongate first electrodes and the plurality of elongate second electrodes apply a DC potential along the ion path.
Example 27. The ion guide of example 23, wherein the plurality of elongate first electrodes and the plurality of elongate second electrodes have a chevron configuration.
Example 28. The ion guide of example 23, wherein the plurality of elongate first electrodes and the plurality of elongate second electrodes are curved.
Example 29. A method of guiding ions within an ion guide, the ion guide comprising a plurality of elongate first electrodes and a plurality of elongate second electrodes arranged along an ion path in an alternating pattern and at an angle oblique to both the ion path and a direction perpendicular to the ion path, the method comprising: applying first RF voltages to the plurality of elongate first electrodes and applying second RF voltages to the plurality of elongate second electrodes to generate a traveling wave potential having a first component that guides ions along the ion path and a second component to confine the ions within the ion path along the direction perpendicular to the ion path; and introducing ions to the ion guide.
Example 30. The method of example 29, wherein the second component of the traveling wave potential is generated without applying a direct current (DC) voltage to the ion guide.

What is claimed is:

1. An ion guide comprising:
a plurality of elongate first electrodes arranged along an ion path and configured to receive first RF voltages; and
a plurality of elongate second electrodes arranged along the ion path in an alternating pattern with the plurality of first electrodes and configured to receive second RF voltages that are phase-shifted with respect to the first RF voltages;
wherein at least an outer edge portion of each of the plurality of elongate first electrodes and the plurality of elongate second electrodes is arranged at a first angle oblique to both the ion path and a direction perpendicular to the ion path.

2. The ion guide of claim 1, wherein, when the plurality of elongate first electrodes receive the first RF voltages and the plurality of elongate second electrodes receive the second RF voltages, the plurality of elongate first electrodes and the plurality of elongate second electrodes apply a traveling wave potential along the ion path and the direction perpendicular to the ion path to guide and confine the ions within the ion path.

3. The ion guide of claim 1, wherein the ion guide does not include guard electrodes extending along a side of the ion path and configured to generate a direct current (DC) confinement field when supplied with a DC voltage.

4. The ion guide of claim 1, wherein the plurality of elongate first electrodes and the plurality of elongate second electrodes are configured to receive DC voltages such that, when the plurality of elongate first electrodes and the plurality of elongate second electrodes receive the DC voltages, the plurality of elongate first electrodes and the plurality of elongate second electrodes apply a DC potential along the ion path.

5. The ion guide of claim 1, wherein each of the plurality of elongate first electrodes and the plurality of elongate second electrodes includes a first portion and a second portion that is substantially symmetrical to the first portion across a central axis of the ion path.

6. The ion guide of claim 1, further comprising:
a plurality of elongate third electrodes arranged along the ion path opposite of the plurality of elongate first electrodes and configured to receive third RF voltages; and
a plurality of elongate fourth electrodes arranged along the ion path opposite of the plurality of elongate second electrodes in an alternating pattern with the plurality of third electrodes and configured to receive fourth RF voltages that are phase-shifted with respect to the third RF voltages;
wherein the plurality of elongate third electrodes and the plurality of elongate fourth electrodes are arranged at a second angle oblique to both the ion path and the direction perpendicular to the ion path.

7. The ion guide of claim 1, wherein the plurality of elongate first electrodes and the plurality of elongate second electrodes have a chevron configuration.

8. The ion guide of claim 1, wherein a span of the plurality of elongate first electrodes and the plurality of elongate second electrodes along the direction perpendicular to the ion path decreases along the ion path to form an ion funnel.

9. The ion guide of claim 1, wherein the plurality of elongate first electrodes and the plurality of elongate second electrodes are curved.

10. The ion guide of claim 9, wherein the plurality of elongate first electrodes and the plurality of elongate second electrodes include an assembly of ring electrodes bent in an arcuate configuration.

11. The ion guide of claim 1, wherein the plurality of elongate first electrodes and the plurality of elongate second electrodes are arranged on a printed circuit board (PCB).

12. The ion guide of claim 1, wherein the ion guide includes a first portion forming a first ion path extending in a first direction and a second portion forming a second ion path connected to the first ion path and extending in a second direction that is different than the first direction.

13. The ion guide of claim 1, wherein the ion path is circuitous in two spatial dimensions or in three spatial dimensions.

14. The ion guide of claim 1, wherein the first angle of the plurality of elongate first electrodes and the plurality of elongate second electrodes relative to the ion path is between about 30 degrees and about 60 degrees.

15. The ion guide of claim 1, wherein the first angle of the plurality of elongate first electrodes and the plurality of elongate second electrodes relative to the ion path is about 45 degrees.

16. The ion guide of claim 1, wherein the plurality of elongate first electrodes and the plurality of elongate second electrodes have a V-shape or a U-shape.

17. An ion mobility separator comprising the ion guide of claim 1.

18. A mass spectrometry system comprising a mass analyzer and the ion guide of claim 1.

19. An ion guide comprising:
a plurality of elongate first electrodes arranged along an ion path and configured to receive first RF voltages; and
a plurality of elongate second electrodes arranged along the ion path in an alternating pattern with the plurality of first electrodes and configured to receive second RF voltages that are phase-shifted with respect to the first RF voltages;
wherein at least an outer edge portion of each of the plurality of elongate first electrodes and the plurality of elongate second electrodes is arranged at an angle relative to the ion path such that, when the plurality of elongate first electrodes receive first RF voltages and the plurality of elongate second electrodes receive second RF voltages, the plurality of elongate first electrodes and the plurality of elongate second electrodes exert a force having a first component along the ion path to guide ions along the ion path and a second component along a direction perpendicular to the ion path to confine ions within the ion path.

20. A method of guiding ions within an ion guide, the ion guide comprising a plurality of elongate first electrodes and a plurality of elongate second electrodes arranged along an ion path in an alternating pattern and at an angle oblique to both the ion path and a direction perpendicular to the ion path, the method comprising:
applying first RF voltages to the plurality of elongate first electrodes and applying second RF voltages to the plurality of elongate second electrodes to generate a traveling wave potential having a first component that guides ions along the ion path and a second component to confine the ions within the ion path along the direction perpendicular to the ion path; and
introducing ions to the ion guide.
